(19) United States
(12) Patent Application Publication
(10) Pub. No.: US 2026/0074575 A1
(43) Pub. Date: Mar. 12, 2026

(54) Integrated Cooling Channels for Stators

(71) Applicant: Vitesco Technologies USA, LLC, Auburn Hills, MI (US)

(72) Inventors: Jigar Mistry, Windsor (CA); Mohammad Hossain Mohammadi, Windsor (CA)

(73) Assignee: Vitesco Technologies USA, LLC, Auburn Hills, MI (US)

(21) Appl. No.: 18/829,939

(22) Filed: Sep. 10, 2024

(51) Int. Cl. H02K 1/20; H02K 1/16

(52) U.S. Cl. CPC H02K 1/20; H02K 1/165

(57) ABSTRACT

A cooling system includes cooling channels integrated into the laminations of a stator, where the laminations are stacked together to form the stator core. The stator has multiple stator slots, and multiple windings extending through the stator slots. The geometry of the cooling channels varies through different groups of the stator laminations. This facilitates the cooling channels being closer to the primary heat source, which are the stator windings, located in the stator slots. The coolant enters the stator geometry via one or multiple inlets on the outer surface of the electric motor, and the cooling channels are shaped such that the coolant is simultaneously distributed radially and axially. The coolant exits the cooling channels from both axial faces through one or multiple outlets, and makes contact with the end windings.

### CROSS-REFERENCE TO RELATED APPLICATIONS

This application claims the benefit of provisional application 65/582,023, filed Sep. 12, 2023. The disclosure of the above application is incorporated herein by reference.

### FIELD OF THE INVENTION

The invention relates generally to a stator of an electric motor having integrated cooling channels.

### BACKGROUND OF THE INVENTION

The operation of an electric motor is significantly impacted by temperature. Electric motors typically have a maximum temperature limit that may be reached during operation. If the maximum temperature limit is exceeded, the performance of the electric motor may be negatively impacted, or the electric motor may fail to operate.

Accordingly, there exists a need for an electric motor which includes various cooling features for achieving desired temperature control during operation.

### SUMMARY OF THE INVENTION

In an embodiment, the present invention is a cooling system for a stator of an electric motor. The cooling system of the present invention enables higher continuous performance for prolonged duration, distributes temperatures more uniformly, and mitigates temperature hotspots.

In an embodiment, the cooling system includes cooling channels integrated into the laminations of a stator, where the laminations are stacked together to form the stator core. The stator has multiple stator slots, and multiple windings extending through the stator slots. The geometry of the cooling channels varies through different groups of the stator laminations. This facilitates the cooling channels being closer to the primary heat source, which are the stator windings, located in the stator slots. The coolant enters the stator geometry via one or multiple inlets on the outer surface of the electric motor, and the cooling channels are shaped such that the coolant is simultaneously distributed radially and axially. The coolant exits the cooling channels from both axial faces through one or multiple outlets and makes contact with the end windings. Since the geometry of the cooling channels in the stator impact the thermal, electromagnetic, and structural performance of the electric motor, a multiphysics-based geometric optimization of the motor is performed to arrive at an optimal geometric design.

The cooling system of the present invention achieves higher continuous performance and improved power density. In an embodiment, there is a plurality of cooling channels distributed circumferentially and axially throughout the stator laminations.

In an embodiment, the present invention is a cooling system for a stator of an electric motor, the cooling system having a plurality of laminations stacked together to form a stator having an axis, an outer inlet channel, a first circumferential channel in fluid communication with the outer inlet channel, a transition channel in fluid communication with the first circumferential channel, and a second circumferential channel in fluid communication with the transition channel. In an embodiment, the cooling system includes a first plurality of distribution elements, each of the first plurality of distribution elements connected to and in fluid communication with the second circumferential channel, and a second a plurality of distribution elements, each of the second plurality of distribution elements connected to and in fluid communication with the second circumferential channel. In an embodiment, the second circumferential channel, the first plurality of distribution channels and the second plurality of distribution channels are integrally formed as part of the plurality of laminations.

In an embodiment, the outer inlet channel, the transition channel, and the first circumferential channel are integrally formed as part of a housing of the stator.

In an embodiment, each of the first plurality of distribution elements includes a first inlet channel connected to and in fluid communication with the second circumferential channel such that the inlet channel protrudes away from the second circumferential channel towards the axis of the stator, a first distribution channel is connected to and in fluid communication with the first inlet channel, and a second distribution channel is connected to and in fluid communication with the first inlet channel. The second distribution channel is substantially parallel to the first distribution channel.

In an embodiment, there is a spacing between the first distribution channel and the second distribution channel such that the second distribution channel is closer to the axis than the first distribution channel.

In an embodiment, the width of at least part of the first inlet channel is the same as the width of the first distribution channel.

In an embodiment, the width of at least part of the first inlet channel is narrower than the width of the first distribution channel.

In an embodiment, the cross section of the first distribution channel is larger than the cross section of the second distribution channel.

In an embodiment, a third distribution channel is connected to and in fluid communication with the first inlet channel. The cross section of the second distribution channel is larger than the cross section of the third distribution channel, and the third distribution channel is closer to the axis than the second distribution channel.

In an embodiment, each of the second plurality of distribution elements includes one or more distribution channels which protrude in the opposite direction along the axis of the stator relative to the first distribution channel and the second distribution channel.

In an embodiment, a plurality of slots integrally formed as part of the stator, at least one of a plurality of coil windings located in a corresponding one of the plurality of slots. Each of the first distribution channel and the second distribution channel are disposed between two of the plurality of slots.

In an embodiment, the upper bound of the plurality of slots is further away from the axis of the stator than the upper bound of the first distribution channel.

In an embodiment, the upper bound of the plurality of slots is closer to the axis of the stator than the upper bound of the first distribution channel.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a first perspective view of a stator having a cooling system, according to embodiments of the present invention;

FIG. 2 is a second perspective view of a stator having a cooling system, according to embodiments of the present invention;

FIG. 3 is a perspective view of various channels which are part of a stator having a cooling system, according to embodiments of the present invention; and

FIG. 4 is a sectional view taken along lines 4-4 of FIG. 1;

FIG. 5 is an enlarged view of a portion of FIG. 4;

FIG. 6 is a perspective view of a section of a stator having cooling windings, where the stator has a cooling system, according to embodiments of the present invention;

FIG. 7 is a sectional view taken along lines 7-7 of FIG. 6;

FIG. 8 is an enlarged view of a portion of FIG. 7;

FIG. 9 is a sectional view of an alternate embodiment of a stator having a cooling system, according to embodiments of the present invention;

FIG. 10 is a first sectional view of another alternate embodiment of stator having a cooling system, according to embodiments of the present invention;

FIG. 11 is a second sectional view of the portion of the stator shown in FIG. 10;

FIG. 12 is a first sectional view of a third alternate embodiment of stator having a cooling system, according to embodiments of the present invention;

FIG. 13 is a second sectional view of the portion of the stator shown in FIG. 12;

FIG. 14 is a perspective view of the portion of the stator shown in FIG. 12; and

FIG. 15 is a sectional view of a section of a stator having a cooling system with a single outlet, according to embodiments of the present invention.

### DETAILED DESCRIPTION OF THE PREFERRED EMBODIMENTS

The following description of the preferred embodiment(s) is merely exemplary in nature and is in no way intended to limit the invention, its application, or uses.

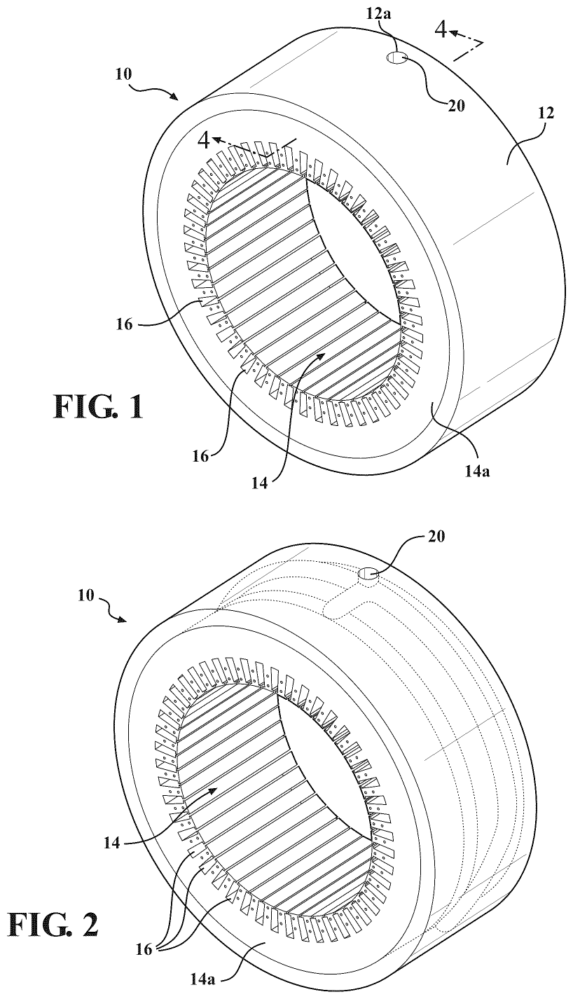

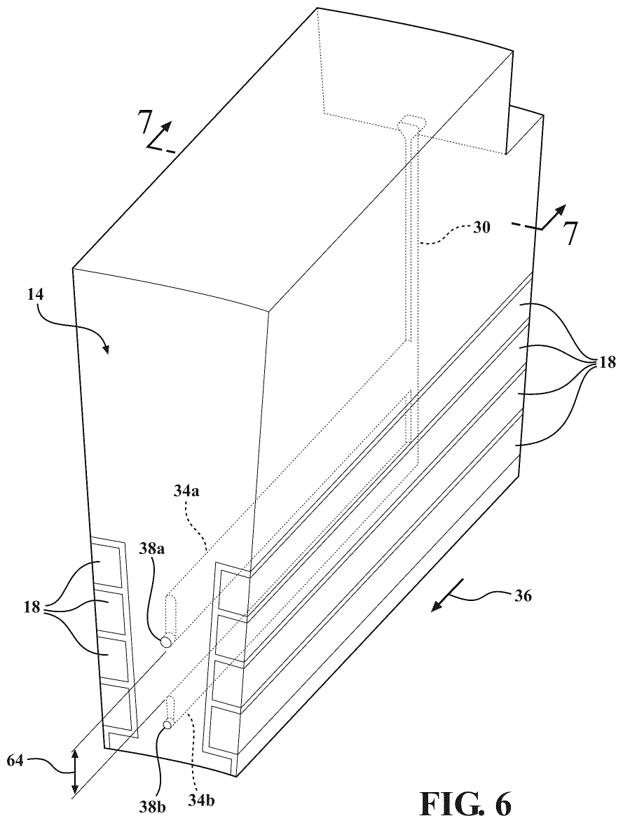

A stator for an electric motor having a cooling system according to the present invention is shown in FIGS. 1-2 at 10. Referring to the Figures generally, the stator 10 includes an outer housing 12 which surrounds a plurality of laminations, shown generally at 14. The plurality of laminations 14, when assembled, form a stator 10 having a plurality of slots 16. Extending through the slots 16 is a plurality of coil windings 18 (shown in FIGS. 6-8).

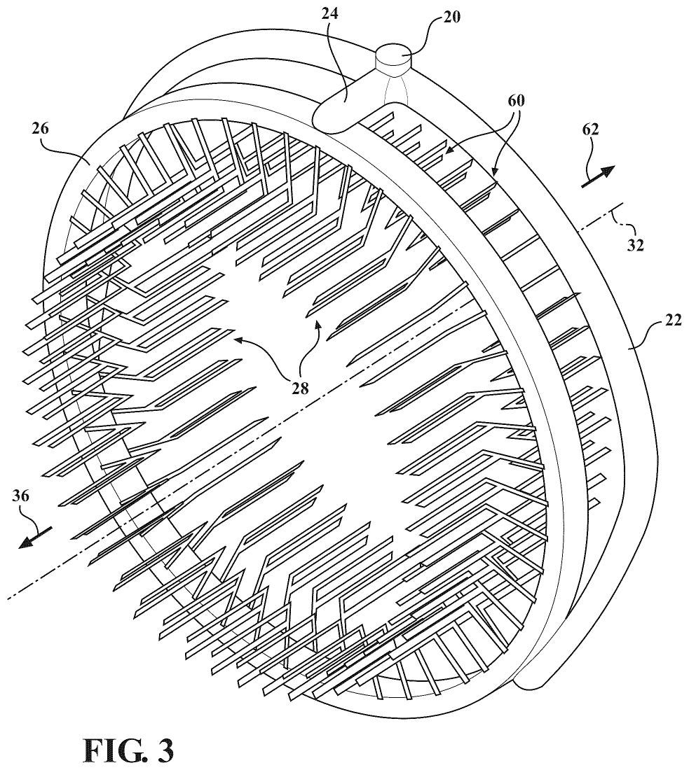

Integrally formed as part of the outer housing 12 is an aperture 12a and extending into the aperture 12a is an outer inlet channel 20, and the outer inlet channel 20 is in fluid communication with a first circumferential channel 22. In an embodiment, fluid may be fed into the outer inlet channel 20 through a hose that is connected to and in fluid communication with an electric pump or a heat exchanger, but it is within the scope of the invention that fluid may be fed into the outer inlet channel 20 using other devices. The outer inlet channel 20 is also in fluid communication with a transition channel 24, and the transition channel 24 is connected to and in fluid communication with a second circumferential channel 26. The first circumferential channel 22 partially circumscribes the laminations 14, and the second circumferential channel 26 completely circumscribes the laminations 14. The first circumferential channel 22 partially circumscribes the laminations 14 (shown in FIGS. 2-3) to ensure that the coolant is distributed uniformly in the axial and circumferential directions around and inside the laminations 14. The outer inlet channel 20, transition channel 24, and circumferential channel 22 are formed as part of the housing 12.

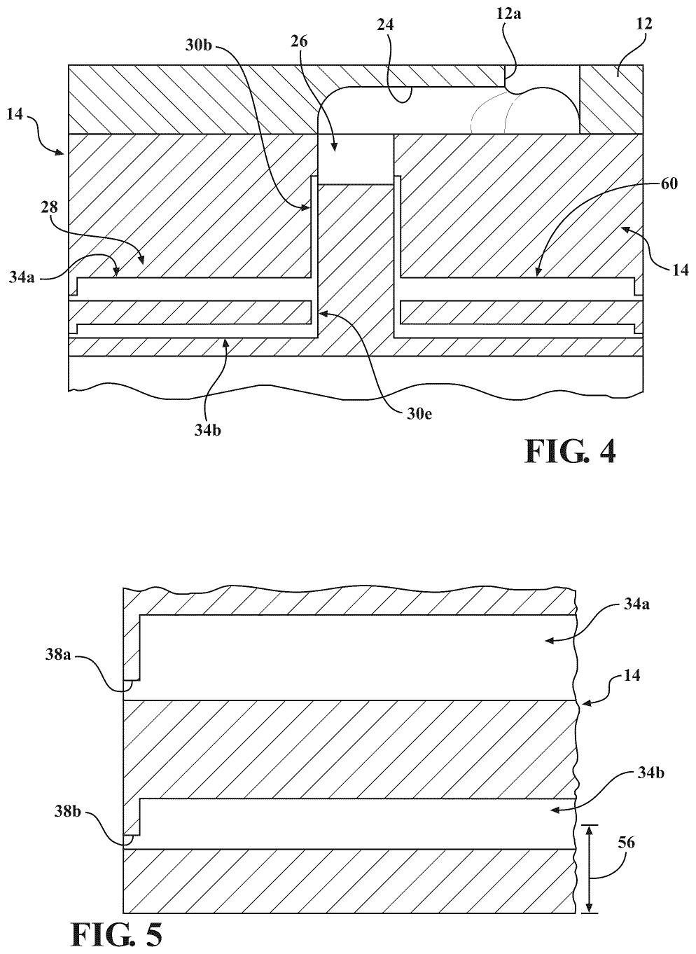

The laminations 14 are shaped such that when the laminations 14 are assembled to form the stator 10, the second circumferential channel 26 and a plurality of fluid distribution elements are formed. Therefore, the second circumferential channel 26 and the fluid distribution elements are all formed as a result of the shape of the laminations 14 when the laminations 14 are assembled to form the stator 10. Each fluid distribution element is substantially similar, therefore only one is described. More specifically, each fluid distribution element, shown generally at 28, is in fluid communication with the second circumferential channel 26. Referring to FIGS. 4-8, the fluid distribution element 28 includes an inlet channel 30, which extends inwardly from the second circumferential channel 26 in a direction toward and perpendicular to an axis 32 (shown in FIG. 3) of the stator 10. The fluid distribution element 28 also includes a first distribution channel 34a and a second distribution channel 34b. Both of the distribution channels 34a,34b extend away from the inlet channel 30 in first direction, indicated by arrow 36 in FIGS. 3 and 6, such that the distribution channels 34a,34b are parallel to the axis 32. The distribution channels 34a,34b are also parallel to each other, and are located at different distances from the axis 32. The first distribution channel 34a has an outlet 38a, and the second distribution channel 34b also has an outlet 38b.

The inlet channel 30 has an inlet area 30a with a tapered cross-section, where the narrowest part of the tapered cross-section of the inlet area 30a corresponds to the width of a first flow area, shown generally at 30b, of the inlet channel 30. The width 30c of the first flow area 30b is consistent across the entire height 30d of the first flow area 30b. The width 30c of the first flow area 30b is independent and separate of the widths of the distribution channels 34a,34b, and in an embodiment, may be different from the widths of the distribution channels 34a,34b. However, in the embodiment shown in FIGS. 1-8, the width of the first distribution channel 34a is the same as the width 30c of the first flow area 30b. The inlet channel 30 also has a second flow area, shown generally at 30e, which has a tapered cross section. The portion 30f of the tapered cross section of the second flow area 30e having the largest width corresponds to the width 30c of the first flow area 30b.

The first distribution channel 34a is connected to and in fluid communication with the first flow area 30b and the second flow area 30e, and the second distribution channel 34b is connected to and in fluid communication with the second flow area 30e.

In the embodiment shown in FIGS. 1-8, the fluid distribution channel 34b has a tapered, or trapezoidal-shaped cross-section, such that the cross-sectional area of the first fluid distribution channel 34a is 2.66 times greater than the cross-sectional area of the second distribution channel 34b (i.e., the cross-sectional area of the second fluid distribution channel 34b multiplied by 2.66 is equal to the cross-sectional area of the first distribution channel 34a). However, the ratio of the size of the cross-sectional areas of the fluid distribution channels 34a,34b may range between the cross-sectional area of the first fluid distribution channel 34a being 2.2 times greater than the cross-sectional area of the second distribution channel 34b, to the cross-sectional area of the first fluid distribution channel 34a being 2.8 times greater than the cross-sectional area of the second distribution channel 34b. In an alternate embodiment, the first fluid distribution channel 34a may have a tapered, or trapezoidal-shaped cross-section.

Referring to FIGS. 6-8, the distance 40 between the upper bound, shown generally at 42, of the slots 16 and the upper bound, shown generally at 44, of the first fluid distribution channel 34a is 0.30 times the height of the first fluid distribution channel 34a. The range for this distance 40 may be between 0.25-0.42, such that the distance 40 between the upper bound 42 of the slots 16 and the upper bound 44 of the first fluid distribution channel 34a may be 0.25-0.42 times the height of the first fluid distribution channel 34a.

Referring again to FIGS. 6-8, the ratio of the width 46 of the upper bound, shown generally at 48 of the second fluid distribution channel 34b to the width 50 of the lower bound, shown generally at 52, of the second fluid distribution channel 34b is 0.68. The width 46 of the upper bound 48 of the second fluid distribution channel 34b corresponds to the portion of the tapered cross section of the second flow area 30e having the narrowest width, and the width 50 of the lower bound 52 corresponds to the diameter of the outlet 38b. More specifically, the width 50 of the lower bound 52 of the second fluid distribution channel 34b is 0.68 times the width 46 of the upper bound 48 of the second fluid distribution channel 34b (i.e., the width 46 of the upper bound 48 of the second fluid distribution channel 34b multiplied by 0.68 is equal to the width 50 of the lower bound 52 of the second fluid distribution channel 34b). However, in other embodiments, this ratio of the widths 46,50 may range between 0.49-0.72.

The midpoint 54 of the second fluid distribution channel 34b is located at a distance 56 from the inner diameter of the stator 10, where the distance 56 is in the range of 0.18-0.35 times the height 58 of the slots 16. In an embodiment, the distance 56 is 0.25 times the height 58 of the slots 16. During operation of the stator 10, the portion of the coil windings 18 closest to the axis 32 typically have the highest temperature due to Eddy current losses and other alternating current phenomena. The second distribution channel 34b of each of the fluid distribution elements 28 facilitates reducing temperature, therefore reducing the effects of alternating current losses.

In an alternate embodiment, both fluid distribution channels 34a,34b have a rectangular cross-section. However, the second fluid distribution channel 34b has a smaller cross-section compared to the first fluid distribution channel 34a. More specifically, the cross-sectional area of the first fluid distribution channel 34a is 1.6 times greater than the cross-sectional area of the second distribution channel 34b (i.e., the cross-sectional area of the second fluid distribution channel 34b multiplied by 1.6 is equal to the cross-sectional area of the first distribution channel 34a). However, it is within the scope of the invention that the ratio of the size of the rectangular cross-sectional areas of the fluid distribution channels 34a,34b may range between the cross-sectional area of the first fluid distribution channel 34a being 1.45 times greater than the cross-sectional area of the second distribution channel 34b, to the cross-sectional area of the first fluid distribution channel 34a being 1.8 times greater than the cross-sectional area of the second distribution channel 34b.

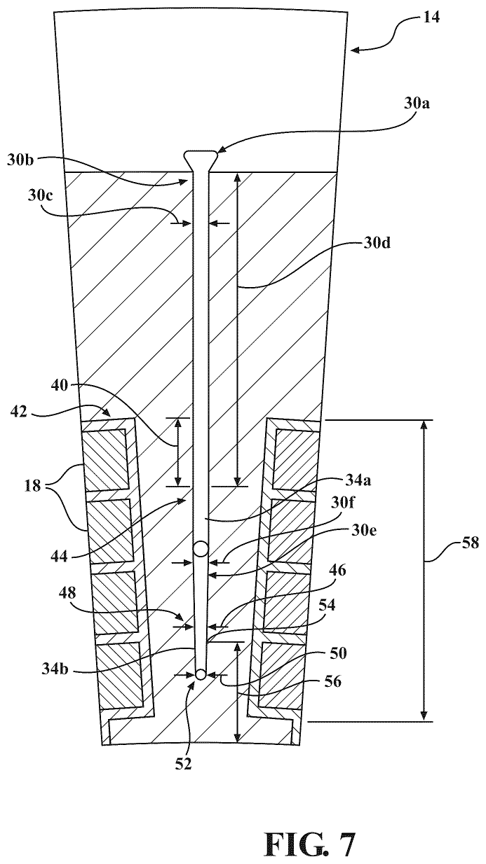

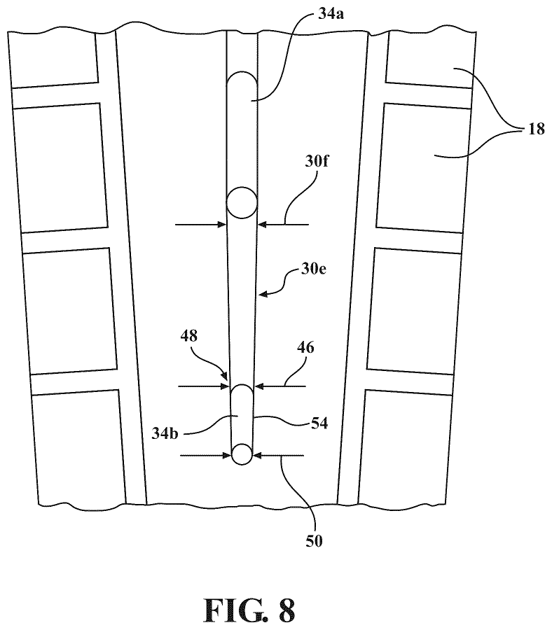

As shown in FIGS. 7-8, the width of the first distribution channel 34a is the same as the width 30c of the first flow area 30b in the area of the inlet channel 30 that the first distribution channel 34a is connected to. Also, the shape of the taper of the cross-section of the second distribution channel 34b corresponds to the shape of the taper of the second flow area 30e, in the area of the inlet channel 30 that the second distribution channel 34b is connected to.

The cross section of the outlet 38a is smaller than the cross section of the first distribution channel 34a, and the cross section of the outlet 38b is smaller than the cross section of the second distribution channel 34b. In the embodiment shown in FIGS. 1-8, the cross-sectional area of the outlets 38a,38b is 2.56 mm², but it is within the scope of the invention that other cross-sectional areas for the outlets 38a,38b could be used, which would change the optimal ratios of the cross-sectional areas of the fluid distribution channels 34a,34b described above.

The cross sections of the first circumferential channel 22, the transition channel 24, and the second circumferential channel 26 all facilitate uniform distribution of coolant, (both axially and circumferentially), and facilitate a uniform coolant velocity across each of the fluid distribution elements 28. Uniform coolant velocity results in a uniform heat transfer coefficient, and therefore a uniform temperature distribution. In an embodiment, the transition channel 24 and the second circumferential channel 26 may have different widths to facilitate coolant distribution.

As mentioned above, in the embodiment shown in FIGS. 1-8, the cross-section of the first fluid distribution channel 34a is rectangular, and the cross-section of the second fluid distribution channel 34b is tapered. The second distribution channel 34b has a smaller cross-sectional area than the first distribution channel 34a, and the second distribution channel 34b is closer to the axis 32 than the first distribution channel 34a. The cross-sectional areas of the flow areas 30b,30e of the inlet channel 30, the distribution channels 34a,34b, and the outlets 38a,38b, also facilitate a reduction in pressure drops, and uniform distribution of coolant to the coil windings 18, and therefore facilitates a uniform heat transfer coefficient, and therefore a uniform temperature distribution within the coil windings 18. The ratio of the cross-sectional area of the first fluid distribution channel 34a being 2.66 times greater than the cross-sectional area of the second distribution channel 34b provides desired performance with regard to temperature and pressure drop, as well as the electromagnetic performance of the electric motor. The lower the ratio of the cross-sectional area of the first fluid distribution channel 34a relative to the cross-sectional area of the second distribution channel 34b, the better the temperature control and less optimal pressure drop, and the higher the ratio of the cross-sectional area of the first fluid distribution channel 34a relative to the cross-sectional area of the second distribution channel 34b, the better the pressure drop performance, with less optimal temperature control.

Furthermore, the cooling performance and pressure drop are a function of the cross-sectional areas of the first flow area 30b, the cross-sectional areas of the fluid distribution channels 34a,34b, and the cross-sectional areas of the outlets 38a,38b, and the aspect ratios of the distribution channels 34a,34b. The aspect ratio of the distribution channels 34a,34b is the ratio of the width to height (i.e., width divided by height). Smaller cross-sectional area combined with a low aspect ratio result in desired temperature control and less optimal pressure drop. High cross-sectional area combined high aspect ratio resulted in desired pressure drop, but less optimal temperature control.

The fluid exits the outlets 38a,38b in the form of a spray in various directions to facilitate the cooling of the ends of the coil windings 18 being saturated with cooling fluid. The spray from the outlets 38a,38b of each fluid distribution element 28 overlaps such that no portion of the ends of the coil windings 18 is dry during operation. The fluid is then collected into a sump (not shown), where the fluid then passes through a filter, and potentially a heat exchanger, before being pumped back into the outer inlet 20 as previously described.

The fluid distribution elements 28 have a first orientation, where the distribution channels 34a,34b of each of the fluid distribution elements 28 extend away from the inlet channel 30 in the first direction 36. The stator 10 having the cooling system according to the present invention also includes fluid distribution elements, shown generally at 60, having a second orientation. Similar to the fluid distribution elements 28, the fluid distribution elements 60 also include an inlet channel 30, where the distribution channels 34a,34b of each of the fluid distribution elements 60 extend away from the inlet channel 30 in a second direction, indicated by arrow 62 in FIG. 3, such that the distribution channels 34a,34b are parallel to the axis 32. The number of fluid distribution elements 28,60 facilitates a reduction in pressure drops and uniform distribution of coolant to the coil windings 18.

As mentioned above, the portion of the coil windings 18 closest to the axis 32 typically have the highest temperature due to alternating current losses. During operation of the stator 10, the second distribution channel 34b of each of the fluid distribution elements 28,60 facilitates reducing temperature, therefore reducing the effects of alternating current losses.

The cross sections of the first circumferential channel 22, the transition channel 24, the second circumferential channel 26, the inlet channel 30 and the distribution channels 34a,34b is chosen to facilitate cooling, while minimizing the distortion of the magnetic flux lines in the stator teeth. In a non-limiting example, the cross-sections of the inlet area 30a, the first flow area 30b, and second flow area 30e of the inlet channel 30 facilitate uniform cooling velocity as mentioned above. Additionally, the cross-sections of the distribution channels 34a,34b may also vary along their respective lengths. In additional embodiments, the cross-sections of the outlets 38a,38b may also be different sizes relative to one another.

The second circumferential channel 26 is located between the ends of the outer housing 12, such that there is equal distance between the second circumferential channel 26 and the ends of the outer housing 12. However, it is within the scope of the invention that the second circumferential channel 26 may be located closer to one of the ends of the outer housing 12, and the lengths of the distribution channels 34a,34b for each of the pluralities of fluid distribution elements 28,60 may be changed to correspond to the change of the location of the second circumferential channel 26.

Referring to FIG. 6, as previously mentioned, the distribution channels 34a,34b are located at different distances from the axis 32, which results in a spacing 64 between the distribution channels 34a,34b. The spacing 64 could vary, depending on the size and shape of the distribution channels 34a,34b, as well as the desired cooling of the stator 10.

The distribution channels 34a,34b for the distribution elements 28,60 having the different orientations are located between the coil windings 18 of the laminations 14. More specifically, the distribution channels 34a,34b of each distribution element 28,60 are disposed between a corresponding two of the slots 16 having the coil windings 18, such that the fluid flowing through the distribution elements 28,60 provides cooling to the windings 18.

It should be noted that although there are two distribution channels 34a,34b shown having the spacing 64 described, it is within the scope of the invention that more or less distribution channels 34a,34b . . . 34∞ having various spacing 64 may be used.

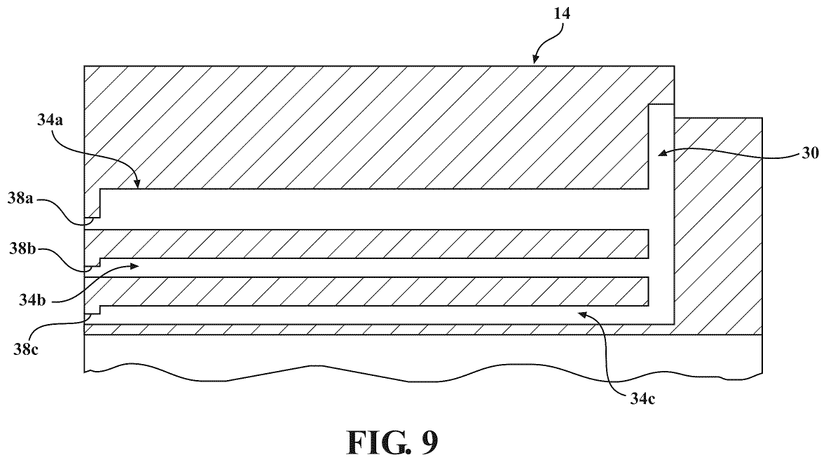

An alternate embodiment of the present invention is shown in FIG. 9, with like numbers referring to like elements. In this embodiment, the inlet channel 30 is also connected to and in fluid communication with a third distribution channel, shown generally at 34c. In the embodiment shown in FIG. 9, the inlet channel 30 is the same length as the inlet channel 30 of the previous embodiment. However, the second distribution channel 34b is located between the first distribution channel 34a and the third distribution channel 34c. Also, in the embodiment shown in FIG. 9, the third distribution channel 34c has a tapered cross section, which corresponds to the shape of the cross-section of the second distribution channel 34b but is smaller. It is however, within the scope of the invention that all of the distribution channels 34a,34b,34c may have a rectangular cross-section. The third distribution channel 34c also has an outlet 38c, which is smaller in cross section compared to the outlet 38b of the second distribution channel 34b. In a similar manner to the embodiment described above, the cross section of the third distribution channel 34c and the cross section of the outlet 38c facilitates a reduction in pressure drops, and uniform distribution of coolant to the coil windings 18, and therefore facilitates a uniform heat transfer coefficient, and therefore a uniform temperature distribution within the coil windings 18.

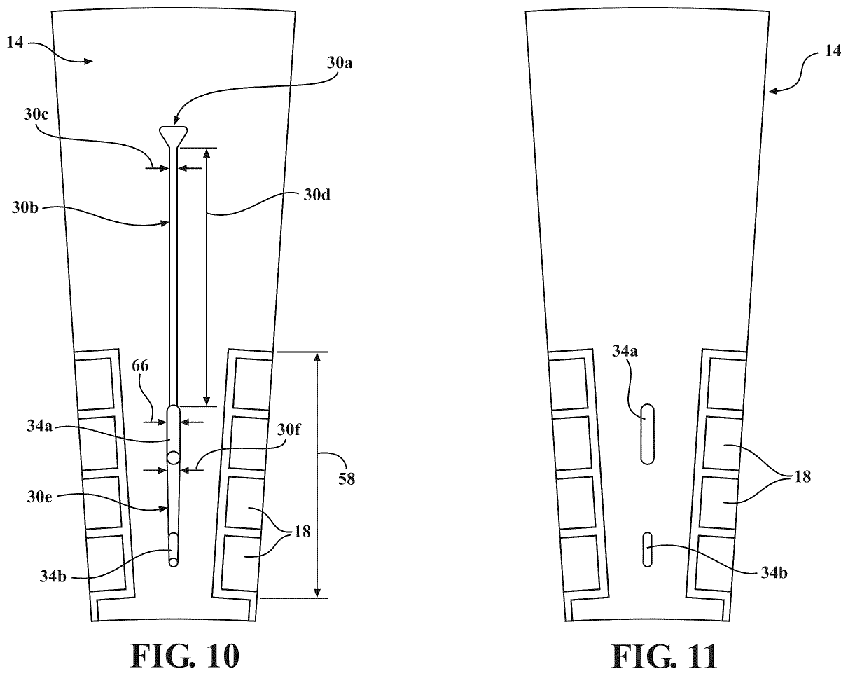

Another alternate embodiment of the present invention is shown in FIGS. 10-11, with like numbers referring to like elements. However, in the embodiment shown in FIGS. 10-11, the width 66 of the first distribution channel 34a is wider than the width 30c of the first flow area 30b, and the second fluid distribution channel 34b is shaped the same as the embodiment shown in FIGS. 1-8. In the embodiment shown in FIGS. 10-11, the ratio of the width 66 of the first distribution channel 34a to the width 30c of the flow area 30b is 0.30-0.65. More specifically, the width 30c of the flow area 30b is 0.30-0.65 times the width 66 of the first distribution channel 34a (i.e., the width 66 of the first distribution channel 34a multiplied by 0.30-0.65 is equal to the width 30c of the flow area 30b).

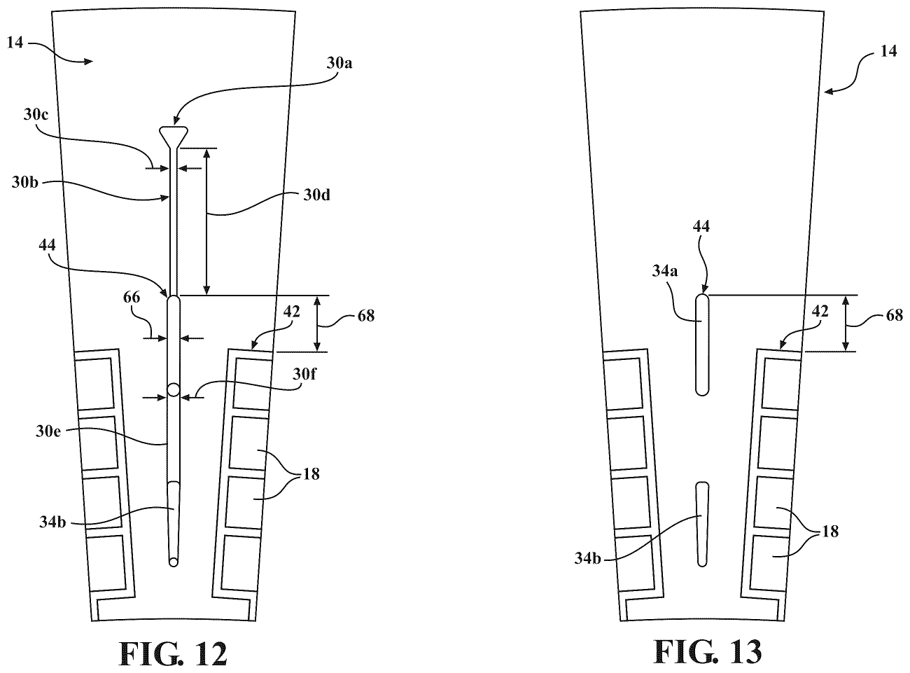

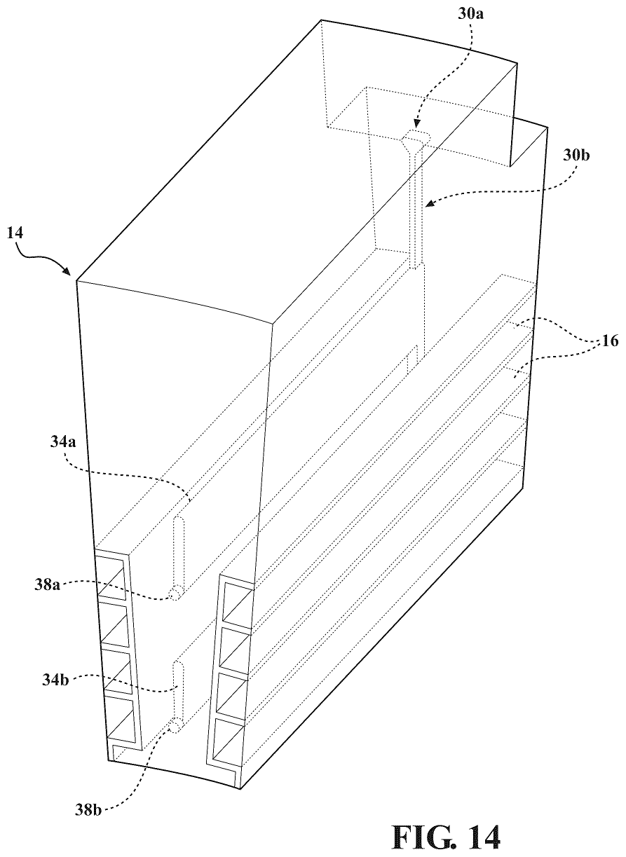

Another alternate embodiment of the present invention is shown in FIGS. 12-14, with like numbers referring to like elements. In this embodiment, the first distribution channel 34a is in a different location compared to the embodiment shown in FIGS. 10-11. The width 66 of the first distribution channel 34a is wider than the width 30c of the first flow area 30b, and the upper bound 44 of the first fluid distribution channel 34a is further away from the inner diameter of the stator 10 than the upper bound 42 of the slots 16. Additionally, the distance 68 between the upper bound 44 of the first fluid distribution channel 34a and the upper bound 42 of the slots 16 is 0.25-0.42 times the height of the first fluid distribution channel 34a. In this embodiment, the second flow area 30e is not tapered, and the width of the second flow area 30e is the same as the width 66 as the first distribution channel 34a and the width 46 of the upper bound 48 of the second fluid distribution channel 34b.

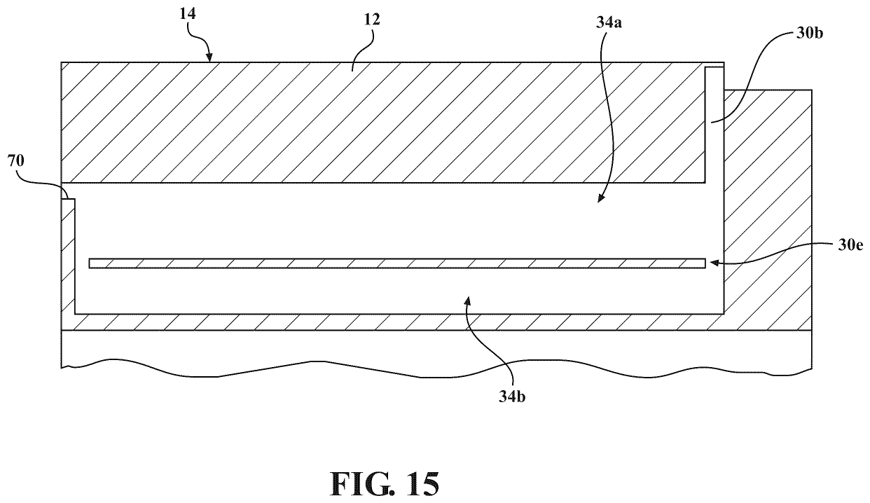

Another embodiment of the present invention is shown in FIG. 15, with like numbers referring to like elements. The embodiment shown in FIG. 15 has a single outlet 70 which both of the fluid distribution channels 34a,34b feed into.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. An apparatus, comprising:
a cooling system for a stator of an electric motor, the cooling system comprising:
a plurality of laminations stacked together to form a stator having an axis;
at least one circumferential channel integrally formed as part of a housing of the stator;
at least one distribution element connected to and in fluid communication with the at least one circumferential channel, the at least one distribution element further comprising:
a first inlet channel connected to and in fluid communication with the at least one circumferential channel such that the first inlet channel protrudes away from the at least one circumferential channel towards the axis of the stator; and
a first distribution channel connected to and in fluid communication with the first inlet channel;
wherein the at least one distribution element is integrally formed as part of the plurality of laminations.

2. The apparatus of claim 1, wherein the width of at least part of the first inlet channel is the same as the width of the first distribution channel.

3. The apparatus of claim 1, wherein the width of at least part of the first inlet channel is narrower than the width of the first distribution channel.

4. The apparatus of claim 1, the at least one distribution element further comprising:
a second distribution channel connected to and in fluid communication with the first inlet channel;
wherein the second distribution channel is substantially parallel to the first distribution channel.

5. The apparatus of claim 4, wherein the cross section of the first distribution channel is larger than the cross section of the second distribution channel.

6. The apparatus of claim 4, further comprising a spacing between the first distribution channel and the second distribution channel, such that the second distribution channel is closer to the axis than the first distribution channel.

7. The apparatus of claim 4, further comprising:
a third distribution channel connected to and in fluid communication with the first inlet channel, the cross section of the second distribution channel is larger than the cross section of the third distribution channel;
wherein the third distribution channel is closer to the axis than the second distribution channel.

8. The apparatus of claim 4, further comprising:
a plurality of slots integrally formed as part of the stator, at least one of a plurality of coil windings located in a corresponding one of the plurality of slots;
wherein each of the first distribution channel and the second distribution channel are disposed between two of the plurality of slots.

9. The apparatus of claim 8, wherein the upper bound of the plurality of slots is further away from the axis of the stator than the upper bound of the first distribution channel.

10. The apparatus of claim 8, wherein the upper bound of the plurality of slots is closer to the axis of the stator than the upper bound of the first distribution channel.

11. The apparatus of claim 1, the at least one distribution element further comprising a second distribution element having one or more distribution channels which protrude in the opposite direction along the axis of the stator relative to the first distribution channel.

12. The apparatus of claim 1, the at least one circumferential channel further comprising:
a first circumferential channel connected to and in fluid communication with an outer inlet channel, the first circumferential channel partially circumscribes the stator; and
a second circumferential channel, the second circumferential channel fully circumscribing the stator, and the at least one distribution element is connected to and in fluid communication with the second circumferential channel;
wherein the first circumferential channel is integrally formed as part of the housing of the stator, and the second circumferential channel is integrally formed as part of the plurality of laminations.

13. The apparatus of claim 12, further comprising a transition channel in fluid communication with the first circumferential channel and the second circumferential channel, the transition channel integrally formed as part of the housing of the stator.

14. A cooling system for a stator of an electric motor, the cooling system comprising:
a plurality of laminations stacked together to form a stator having an axis;
an outer inlet channel;
a first circumferential channel in fluid communication with the outer inlet channel;
a transition channel in fluid communication with the first circumferential channel;
a second circumferential channel in fluid communication with the transition channel;
a first plurality of distribution elements, each of the first plurality of distribution elements connected to and in fluid communication with the second circumferential channel; and
a second plurality of distribution elements, each of the second plurality of distribution elements connected to and in fluid communication with the second circumferential channel;
wherein the second circumferential channel, the first plurality of distribution elements, and the second plurality of distribution elements are integrally formed as part of the plurality of laminations.

15. The cooling system for a stator of an electric motor of claim 14, wherein the outer inlet channel, the transition channel, and the first circumferential channel are integrally formed as part of a housing of the stator.

16. The cooling system for a stator of an electric motor of claim 15, each of the first plurality of distribution elements further comprising:
a first inlet channel connected to and in fluid communication with the second circumferential channel such that the inlet channel protrudes away from the second circumferential channel towards the axis of the stator;
a first distribution channel connected to and in fluid communication with the first inlet channel; and
a second distribution channel connected to and in fluid communication with the first inlet channel;
wherein the second distribution channel is substantially parallel to the first distribution channel.

17. The cooling system for a stator of an electric motor of claim 16, further comprising a spacing between the first distribution channel and the second distribution channel, such that the second distribution channel is closer to the axis than the first distribution channel.

18. The cooling system for a stator of an electric motor of claim 16, wherein the width of at least part of the first inlet channel is the same as the width of the first distribution channel.

19. The cooling system for a stator of an electric motor of claim 16, wherein the width of at least part of the first inlet channel is narrower than the width of the first distribution channel.

20. The cooling system for a stator of an electric motor of claim 16, wherein the cross section of the first distribution channel is larger than the cross section of the second distribution channel.

21. The cooling system for a stator of an electric motor of claim 16, further comprising:
a third distribution channel connected to and in fluid communication with the first inlet channel, the cross section of the second distribution channel is larger than the cross section of the third distribution channel;
wherein the third distribution channel is closer to the axis than the second distribution channel.

22. The cooling system for a stator of an electric motor of claim 16, each of the second plurality of distribution elements further comprising one or more distribution channels which protrude in the opposite direction along the axis of the stator relative to the first distribution channel and the second distribution channel.

23. The cooling system for a stator of an electric motor of claim 16, further comprising:
a plurality of slots integrally formed as part of the stator, at least one of a plurality of coil windings located in a corresponding one of the plurality of slots;
wherein each of the first distribution channel and the second distribution channel disposed between two of the plurality of slots.

24. The cooling system for a stator of an electric motor of claim 23, wherein the upper bound of the plurality of slots is further away from the axis of the stator than the upper bound of the first distribution channel.

25. The cooling system for a stator of an electric motor of claim 23, wherein the upper bound of the plurality of slots is closer to the axis of the stator than the upper bound of the first distribution channel.
